(19) United States
(12) Patent Application Publication
(10) Pub. No.: US 2016/0012392 A1
(43) Pub. Date: Jan. 14, 2016

(54) METHOD FOR PROVIDING A PAPERLESS DELIVERY RECEIPT WITH ELECTRONIC SIGNATURE

(71) Applicant: Old Dominion Freight Line, Inc., Thomasville, NC (US)

(72) Inventors: Scott Paden, Thomasville, NC (US); Nag Akki, Thomasville, NC (US); Charles Sheek, Thomasville, NC (US); Daniel Neumann, Thomasville, NC (US); Harlow Lee King, JR., Thomasville, NC (US); MaryLou T. Rychlicki, Thomasville, NC (US); David Williams, Thomasville, NC (US); Barry Craver, Thomasville, NC (US); Dennis Phelps, Thomasville, NC (US)

(21) Appl. No.: 14/536,816

(22) Filed: Nov. 10, 2014

Related U.S. Application Data
(60) Provisional application No. 62/023,048, filed on Jul. 10, 2014.

(51) Int. Cl. G06Q 10/08; G06T 11/60

(52) U.S. Cl. CPC G06Q 10/0838; G06T 11/60; G06T 2207/30176

(57) ABSTRACT

A networked computer system comprising a computer or a server having a computer software application for generating a paperless delivery receipt for a shipment by a carrier, a mobile device for downloading the paperless delivery receipt, and a computer user interface on the mobile device for capturing an electronic signature associated with the paperless delivery receipt.

### CROSS-REFERENCE TO RELATED APPLICATIONS

This application claims priority from U.S. patent application Ser. No. 62/023,048, filed on Jul. 10, 2014, in the United States Patent and Trademark Office. The disclosure of which is incorporated herein by reference in its entirety.

### FIELD OF THE INVENTION

The present invention relates to a method and system for providing a paperless delivery receipt, more particularly to a method and system for providing a paperless delivery receipt with an electronic signature.

### BACKGROUND

Carriers have used various methods over the years for collection of signatures at point of delivery, but such methods have primarily been manual. The consignee, who is the company or individual receiving a shipment, typically signs multiple printed delivery receipts. The printed delivery receipts are typically printed prior to a driver's departure. Therefore, such printed delivery receipts are only timely up to the specific time of printing. A copy is retained by the consignee, and another copy is retained by the driver. The driver's copy is then manually scanned and processed at the end of the day. The manual processing of delivery receipts is labor intensive. Other carriers print delivery receipts in their truck at the point of delivery. This point of delivery printing is costly and incurs high maintenance of in-truck printers. It is possible to scan printed delivery receipts at the point of delivery as well, but this again incurs significant equipment costs and is time consuming. Furthermore, some package and LTL (Less Than Truckload) carriers collect signatures but do not offer the detailed information about the delivery or shipment often expected or needed by the consignee prior to signing Consignees expect more details at the point of delivery particularly with LTL and whole trailer shipments due to the larger size and cost of the deliveries. The computer-implemented system and method of the present invention solves a technological problem in a conventional industry practice of pickup and delivery services.

Accordingly, there is a need for a method that reduces printing costs, reduces labor costs, accesses data timely by the consignee at point of delivery, provides for faster billing, and reduces the costs associated with the need for additional equipment to print or scan delivery receipts and other documents at the point of delivery. This invention is an improvement over existing systems and methods that necessitate manual handling of delivery receipts.

### SUMMARY

The present invention provides a computer-based system and method for generating, delivering and signing electronic delivery receipts. Mobile devices with computer software application user interfaces having various technical and functional features are also set forth herein.

Further areas of applicability of the present invention will become apparent from the detailed description provided hereinafter. It should be understood that the detailed description and specific examples, while indicating an embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is an illustration of a traditional paper delivery receipt having a handwritten signatures, handwritten notes and other handwritten business critical data not in accordance with the present invention.

FIG. 2 is a diagram illustrating an environment in which the networked computer system of the present invention may operate.

FIG. 3 is a flowchart illustrating an embodiment of the system and computer-implemented method of the present invention.

FIGS. 4A and 4B illustrate images associated with paperless delivery receipts in accordance with aspects of the present invention.

FIG. 5 illustrates a “Stop Detail” user interface for use with a paperless delivery receipt in accordance with aspects of the present invention.

FIG. 6 illustrates a consignee signature user interface for use with a paperless delivery receipt in accordance with aspects of the present invention.

FIG. 7 illustrates a user interface for Accessorial Services in accordance with aspects of the present invention.

FIG. 8 is an illustration of a user interface from a handheld computer for a tally count in accordance with aspects of the present invention.

FIGS. 9A, 9B and 9C are illustrations of user interfaces for exceptions such as for a “Delivery Exception” or other shipment anomalies in accordance with aspects of the present invention.

FIGS. 10A and 10B illustrate user interfaces for other graphical and generic file and data types including photographic documentation in accordance with aspects of the present invention.

FIGS. 11A-11D illustrate an accident photo user interface in accordance with aspects of the present invention.

### DETAILED DESCRIPTION OF THE INVENTION

The following description of the embodiments of the present invention is merely exemplary in nature and is in no way intended to limit the invention, its application, or uses. The present invention has broad potential application and utility, which is contemplated to be adaptable to a wide range of users for providing pickup and delivery services. The following description is provided herein solely by way of example for purposes of providing an enabling disclosure of the invention, but does not limit the scope or substance of the invention.

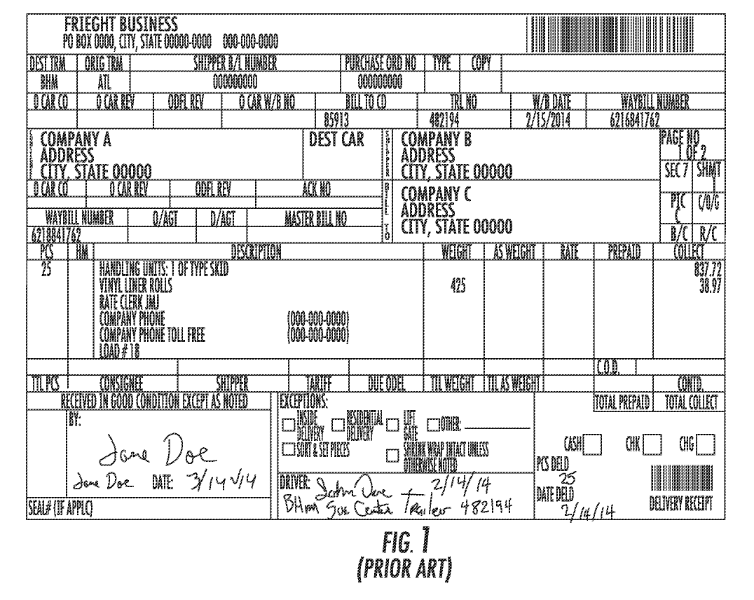

FIG. 1 is an illustration of a traditional paper delivery receipt having a handwritten signature, handwritten notes and other handwritten business critical data not in accordance with the present invention. The networked computer system and method of the present invention overcomes the disadvantages and problems associated with manual delivery receipts.

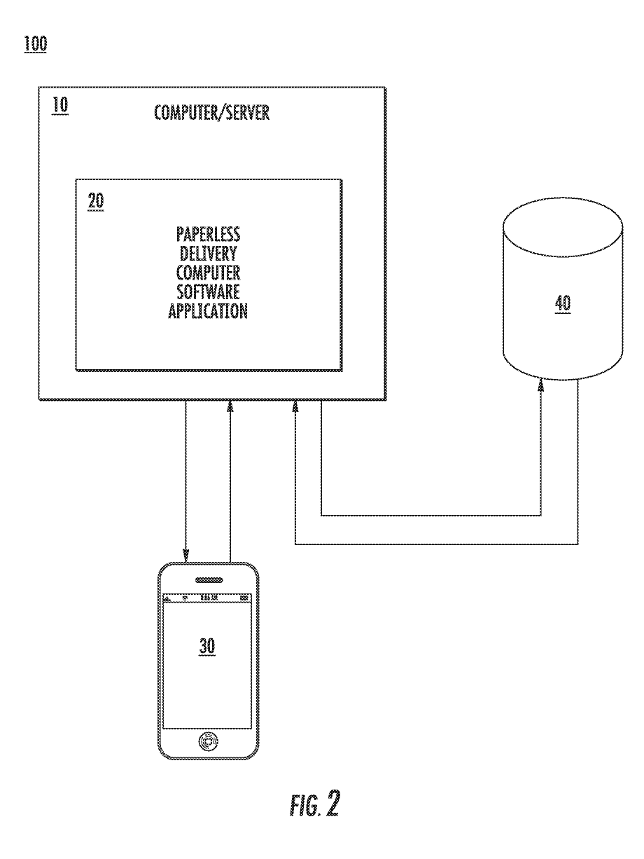

FIG. 2 is a diagram illustrating an environment 100 in which the networked computer system of the present invention may operate. As shown in FIG. 2, a networked computer system in accordance with the present invention comprises one or more computers and/or servers having a computer processor(s) and memory 10 communicatively connected to one another. Typically, in the context of the present invention, the computer network is a telecommunications network of a carrier or of an authorized third party of the carrier. “Carrier,” as used herein, refers to an individual or a company that transports goods and/or people by air, land or sea, in its own or chartered vessels or equipment (such as trailers). A computer software application(s) 20 is designed for use with the computer hardware and software in the networked computer system, particularly a handheld mobile device 30. The computer software application 20 is used for purposes including, but not limited to, compiling and processing information for use on the computer-based mobile device(s) 30. The computer software application 20, for example, is used to assemble entered shipment information into a computer database(s). In addition to the shipment information, the entered information may include customer/consignee information and route information. “Consignee,” as used herein, refers to a recipient of a shipment. The mobile device 30 communicates over the computer network (such as a wireless computer network) with the computer or server 10. The user of the mobile device 30 uses a computer software application user interface on the mobile device 30 to communicate with the computer or server 10. The computer system including the computer software application user interface on the mobile device is used to create or generate delivery receipts, manifests, routes and other information. Data may be stored in a database 40.

The mobile device 30 shown in FIG. 1 comprises a touch screen. A touch screen is a screen capable of detecting contact on its surface. Resistive touch screen technology can be used to capture input from a stylus or finger. A single point of pressure is applied to the screen which in turn is translated into the signature being drawn in the location of the pressure. Capacitive touch screen technology can also be used. A capacitive touch screen translates electrical impulses on the surface of the screen into the signature. With these screen types, a finger is used to detect input on the screen. In addition, there are specialized styli which will work with this screen type. For example, with a resistive touch screen device, a passive stylus is used to accurately capture a signature. With a capacitive touch screen device, there are styli that conduct the electrical impulses from the users hand to a capacitive screen.

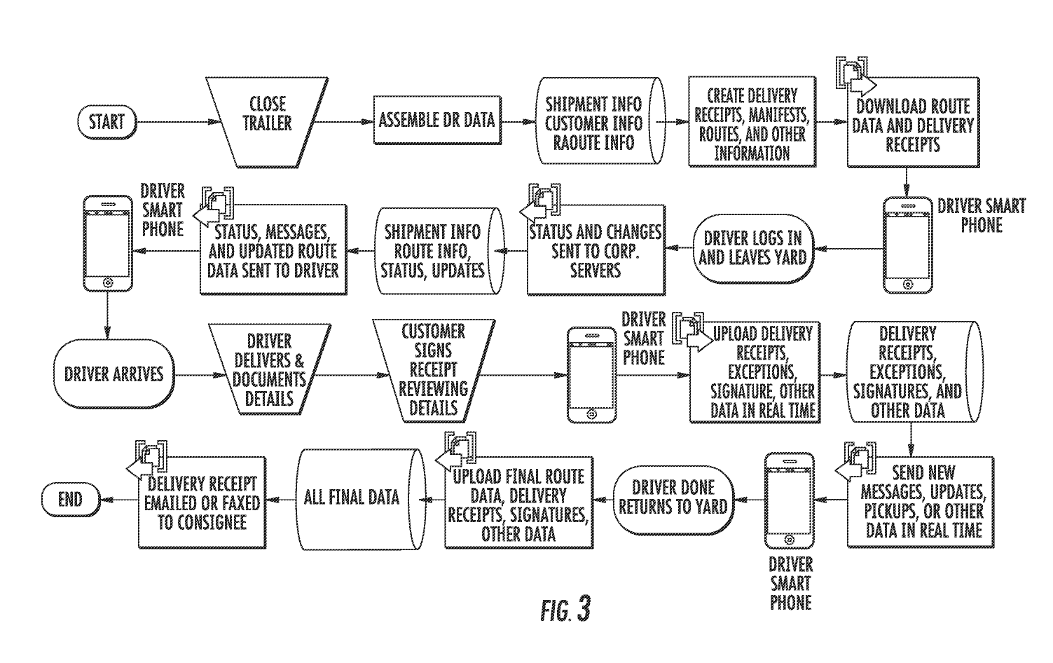

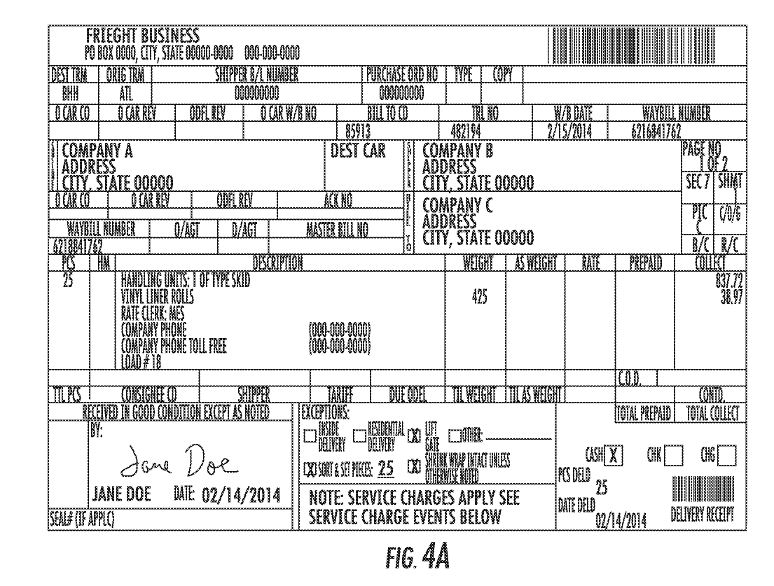

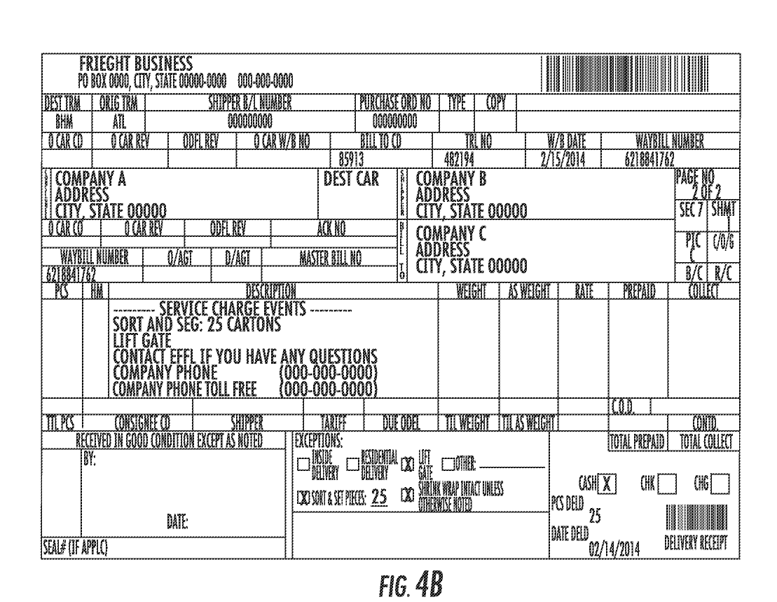

FIG. 3 is a flowchart illustrating an embodiment of the system and computer-implemented method of the present invention. As shown in FIG. 3, an employee of a carrier or other party acting on behalf of the carrier loads and closes a trailer. “Close,” as used herein, refers to the process of physically closing a trailer. The close may initiate assembly of delivery receipt (DR) data and information about a shipment. Among the reasons that the computer or server 10 is special and unique to the transportation industry is that it can process route information received from other computers and compile that information with information and data relating to close of a trailer for generation of a paperless delivery receipt in conjunction with the paperless delivery receipt computer software application 20 and mobile device 30. Assembling data and information may include, but is not limited to, creating delivery receipts, printing manifests, providing documentation to dispatchers, and building a route. “Route,” as used herein, refers to a list or a database of the stops of a driver, shipment details, consignee information, and other information to be used by a driver and accessible with a mobile device. The method of the present invention may be employed, for example, on a delivery route. “Delivery receipt,” as used herein, refers to the specific details associated with a delivery including but not limited to the shipper, changes to the consignee, services rendered at the point of delivery, hazardous materials (HAZMAT) information, special shipment instructions, and other information. FIGS. 4A and 4B illustrate images associated with paperless delivery receipts generated in accordance with aspects of the present invention. The mobile device comprises a computer software application user interface.

As shown in FIG. 3, the route data and delivery receipt are downloaded from the computer network to a mobile device which may be a Smartphone or other handheld computer. “Handheld computer,” as used herein, refers to a handheld computer that may be used by the driver to track the status of shipments and other details associated with the trailer.

The driver logs into the handheld computer that is communicatively connected to the computer network and leaves the yard. The handheld computer has the ability to communicate data from the point of delivery to or from the computers and/or servers of the networked computer system. The handheld computer has Full Featured Operating Systems (FFOS) which support a rich set of database features, wireless data communications, symbol scanning (such as QR Codes), human signature capture, image processing, and photography. Using the handheld computer, the driver documents and enters information about the shipment into the computer network.

Status and changes are sent by the driver using the handheld device to a computer or server in the computer network. Shipment information, route information, status and updates are stored in a computer database(s). Status, messages and updated route data are also sent to the handheld device of the driver. For example, charges for the consignee may be changed just prior to the driver arriving at a stop. “Stop,” as used herein, refers to a location where a shipment is either picked up or delivered. One or more shipments may be associated with a single stop. Once a driver arrives at a specific stop, the driver then processes the shipments associated with that stop. During the course of delivery, the driver uses the handheld computer to transmit details back to the computer network from the handheld computer using wireless communications. During delivery or pick-up activities at a stop, the driver may add text notes associated with the shipment.

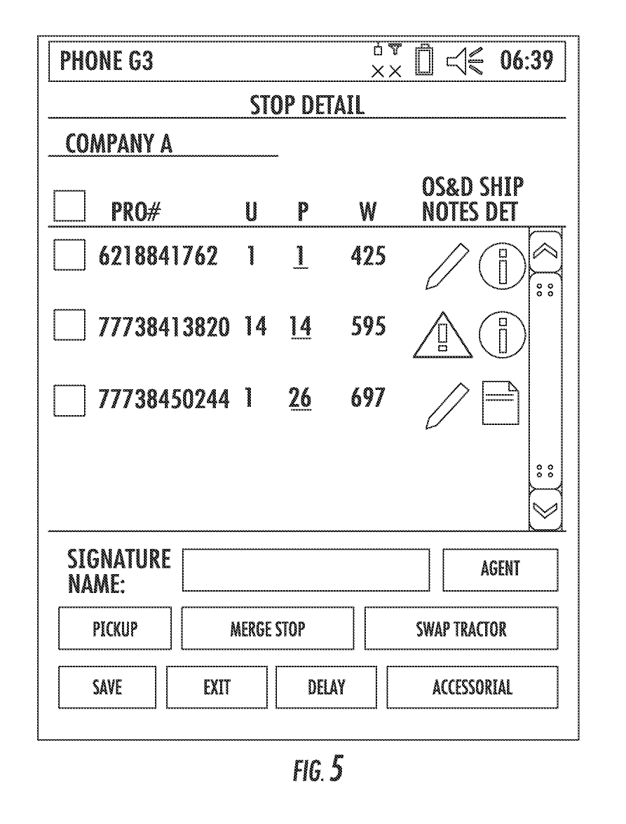

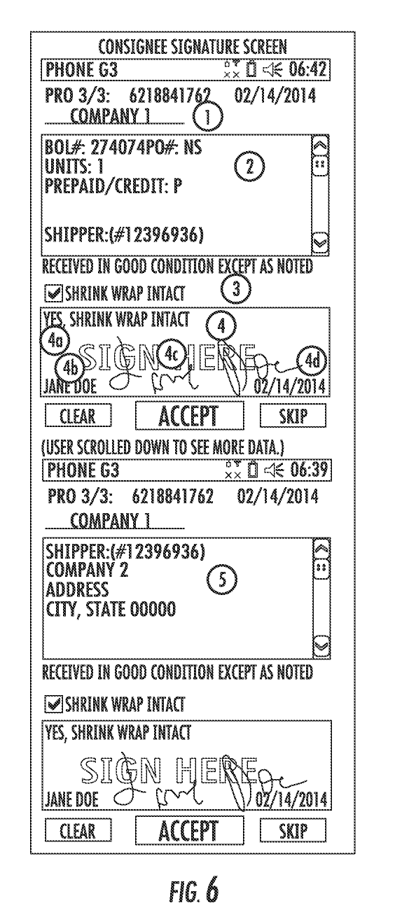

When a driver arrives, the driver delivers the shipment and documents details by providing a delivery receipt to a consignee at a point of delivery. Once the driver has completed documenting the delivery, the driver uses the interactive display or computer screen of the handheld device to transmit instructions. For example, as shown in FIG. 6, the driver presses SAVE and the handheld computer advances to the signature screen allowing the consignee to sign for the shipment. The consignee can review the details of delivery, ask the driver to note issues associated with the delivery, and sign for the delivery. The consignee can review the delivery receipt details by scrolling through the details on the signature screen. The consignee can accept a delivery or press SKIP and move to the next shipment in the delivery, if one exists. The consignee presses SKIP allowing the driver and consignee to decide how to handle a specific problem. For example, the driver can contact the carrier to remedy issues with a shipment.

It is possible for the driver to enter specific details associated with the shipment through an OS&D exception process. “OS&D,” as used herein, refers to an acronym for Overage, Shortage, and or Damaged (OS&D). OS&D is a process where shipment exceptions are managed. A driver contacts a representative of the carrier, for example, who has the authority to handle and remedy an exception claim to the satisfaction of the consignee. Often shipments with exceptions are kept by the consignee. The system and method of the present invention accommodates the OS&D process. The driver can also indicate monetized services, called Accessorial Services, rendered for a shipment. “Accessorial Services,” as used herein, refers to services rendered by a driver at a delivery or pickup location that may be billed to the consignee, shipper, or third party. Accessorial services are tracked in real time and sent back to a corporate database for billing. The driver can also update a delivery receipt to reflect charges incurred during a particular delivery such as Sorting and Segregation. “Sorting and Segregation” (also called “Sort and Seg”), as used herein, refers to when the driver breaks down a shipment and sorts and, or separates the pieces of the shipment into an organization requested by the consignee. The time and number of units are tracked by the handheld computer and are reflected in the paperless delivery receipt.

The consignee signs for the delivery using the handheld computer of the driver. Once the consignee signs and presses ACCEPT, the electronic signature is captured and encoded in a graphic file format. “Electronic signature,” as used herein, refers to a handwritten graphic signature and other metadata associated therewith. The signature can be compressed and encoded in a variety of file formats appropriate for the situation. These include, but are not limited to, JPEG, TIFF, PNG, among others. The signature data is eventually encoded into wireless Signature Object suitable for transmission over wireless communication. “Signature Object,” as used herein, refers to a data object containing a signature and other information suitable for wireless communications. The Signature Object is encoded and compressed into a format suitable for wireless transport to a computer network. Various formats can be selected and can be changed as needed. The object is decoded on the computer network back into a useable graphic format such as JPEG for processing.

After the signature is captured, the signature is merged with an electronic copy of the delivery receipt. The delivery receipt information and signature are encoded and sent to the computer or server in the networked computer system.

The resulting paperless, electronic delivery receipt is optionally transmitted to the consignee. As a feature of the system and method of the present invention, the consignee can also enter a specific email address or FAX number. The delivery receipt may be transmitted via e-mail, short message service (SMS), instant message, fax or other electronic method. The consignee may also retrieve the delivery receipt from a designated website. The website allows a user to register, view, and retrieve the delivery receipt. Manual scanning of the delivery receipt is not required at any point using the method of the present invention.

After the consignee signs, the driver uses the handheld computer to upload delivery receipts, exceptions, signatures, and other data in real time. A computer database stores the delivery receipts, exceptions, signatures, and other data. The computer network sends new messages, updates, pickups or other data in real time to the handheld computer of the driver. When the driver is done, the driver returns to the yard. The final route data, delivery receipts, signatures and other data are uploaded to the computer network. All final data is stored. The delivery receipt is optionally e-mailed or faxed to the consignee or, the consignee or shipper may go to a website and download the delivery receipt.

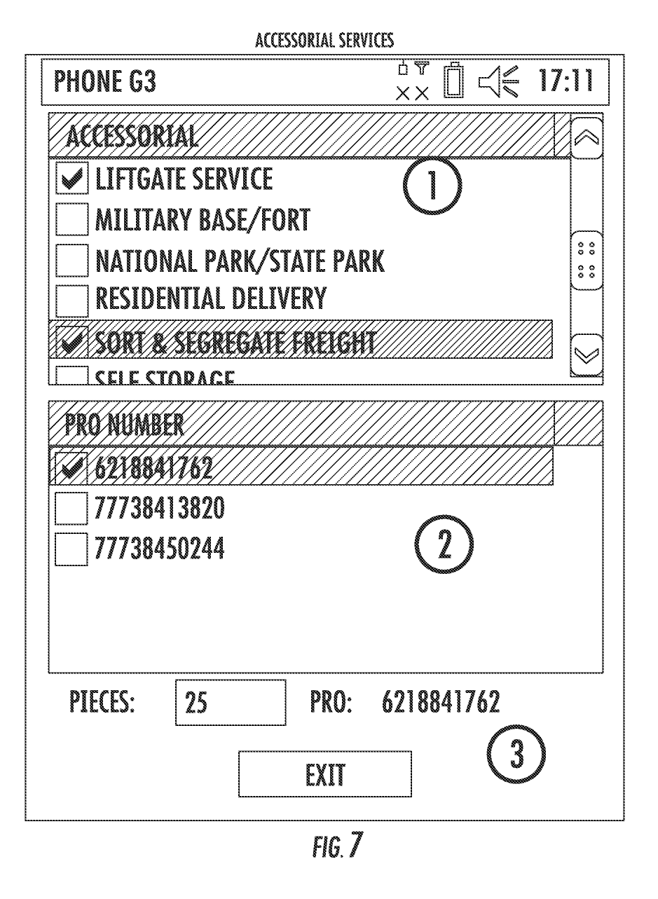

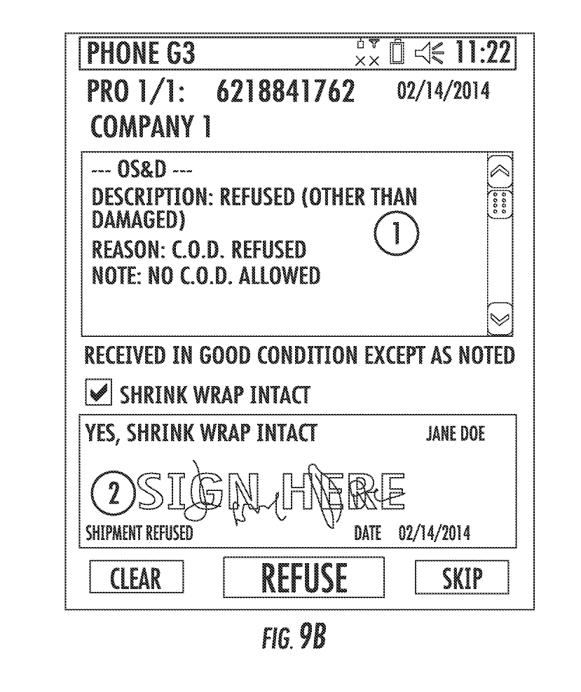

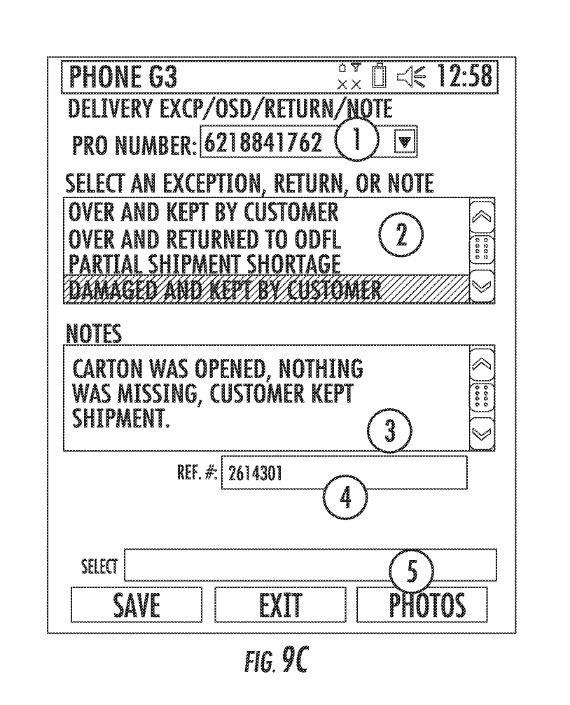

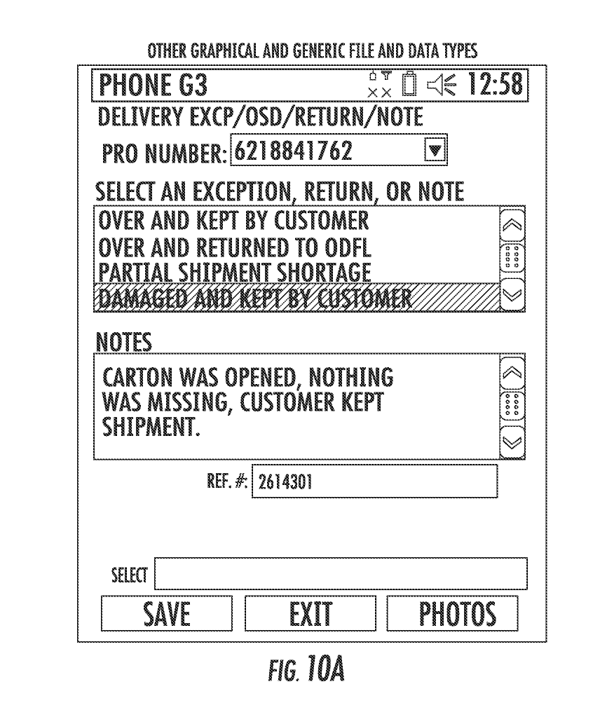

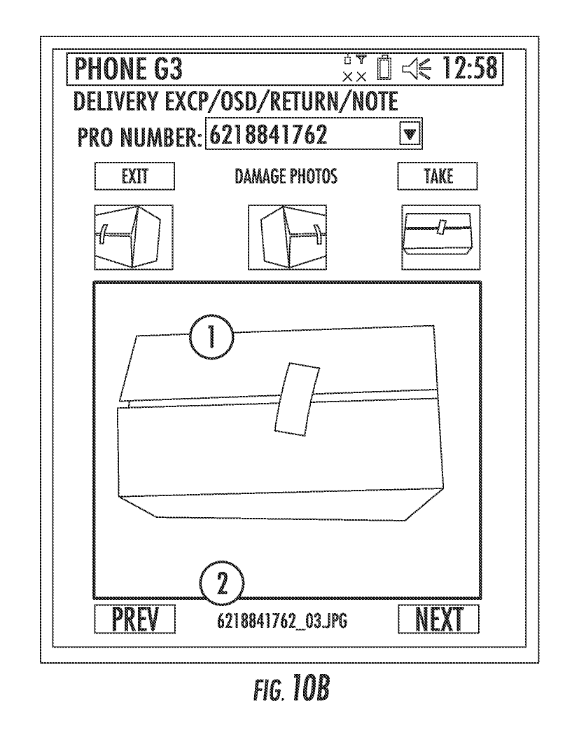

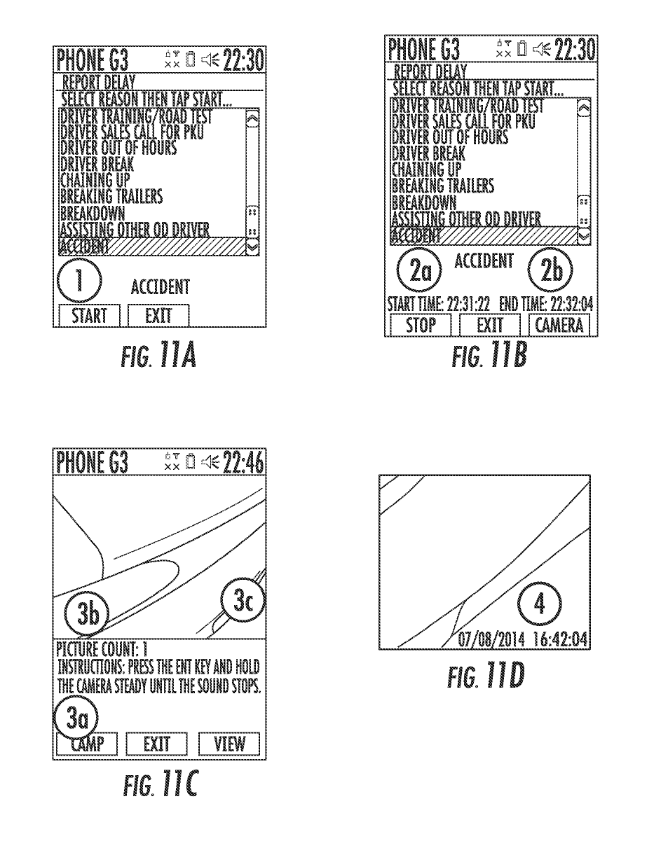

It should be noted that other types of computer files may be transmitted to computers and/or servers in the networked computer system using the same or similar infrastructure. For example, drivers may be asked to manually count shipments. In another aspect of the present invention, the computer system and method provides a tally subsystem where the driver can strike the screen or press a button for each carton counted. The tally information is passed back to the networked computer system. FIG. 8 is an illustration of a computer screen shot from a handheld computer for a tally count. In another example, a photograph documenting shipment exceptions can be captured and tracked as part of the exception process. FIGS. 10A and 10B illustrate user interfaces for other graphical and generic file and data types including photographic documentation. FIGS. 11A-11D illustrate an accident photo user interface in accordance with aspects of the present invention.

The method of providing a paperless delivery receipt with signature capture in accordance with the present invention reduces labor and printing costs. It also provides more timely information to consignees. The advantages associated with the method of the present invention include, but are not limited to, the following. The method does not require end of day scanning. The method reduces printing costs. The method reduces equipment costs because printers wear out less often and fewer printers are needed. The method utilizes existing infrastructure so no additional equipment is needed such as in-truck printers or in-truck sheet scanners. The method can provide a real-time response to consignees. The term “real-time,” as used herein, also includes near real-time and real time enough response times as understood by one of ordinary skill in the art. The method may eliminate manual mistakes because delivery receipts are not shuffled from the driver to the dispatchers to the clerks to the hopper scanners. Manual tally counts at the point of delivery are tracked electronically and may be accessed via software rather than only relying on a visual confirmation by looking at a scanned score. The method provides more information about shipments since notes about the shipment are captured at the point of delivery rather than read off of printed delivery receipts at the end of the day. The method can provide more accurate delivery receipts to consignees at the point of delivery because the data can be updated after the driver leaves the service center. The present invention may also utilize paper delivery receipts.

Another aspect of the system and method of the present invention is that it is possible to customize the paperless delivery receipt at time of electronic signature in a way that is not possible with a paper delivery receipt. The paperless delivery receipt is generated with the benefit of having interactive links or buttons that are incorporated in the computer software application user interface and viewable with the handheld device. These links or buttons may be used by the driver or the consignee at point of delivery to input information or make selections. For example, FIGS. 5, 6, 7, 8, and 9A-9C illustrate such features of the computer software application user interface.

FIG. 5 illustrates a “Stop Detail” screen for use with a paperless delivery receipt. The computer screen of the handheld computer displays the following information and provides the following functionality. The “Exit” button returns to the previous screen. The “Delay” button allows a driver to enter delay information not chargeable to the consignee or shipper such as traffic delays, etc. The “Accessorial” button allows the driver to specify service charge events such as “Lift Gate” and “Sort and Segregate.” A “Lift Gate” service typically means that the driver utilized a hydraulic or electrical lift to bring shipments from ground level to the trailer or from the trailer to ground level. Not all trailers have lift gates, so carriers typically charge if a lift gate is required to retrieve or to deliver a shipment to or from a specific location. An information (i) icon allows the driver to read specific delivery receipt information about the shipment. The information icon also indicates that the shipment is using a paperless delivery receipt and that the driver needs to collect an electronic signature. A “paper” or “tablet” icon indicates that this is a paper-only delivery receipt that the consignee must sign by hand and will be processed using image scanning and manual processes. The “pen” or “pencil” icon allows the driver to enter exceptions or to make notes associated with a delivery and provides the driver a chance to document various information deemed important by the consignee. A triangle icon with the exclamation point is used, for example, to indicate that the driver has entered an exception associated with the shipment. The “pickup” button allows the driver to enter information about a shipment to be picked-up at the same stop. The “merge stop” button allows a driver to insert other shipments into a delivery stop when the shipments appear in different stops. The “Swap tractor” button allows the driver to document that he or she has swapped a tractor during the stop. The “Save” button allows the driver to save the selected shipment information.

FIG. 6 illustrates a consignee signature screen for use with a paperless delivery receipt. The following features of the consignee signature screen are illustrated. Item 1 identifies the PRO number, date the shipment was originated, and consignee associated with a delivery. “PRO Number,” as used herein, refers to a unique identification number referencing a specific shipment of merchandise. A PRO can be displayed as a number or machine readable scan code such as a code 39 symbol or QR code. The consignee may be an active link that can be clicked on to pull up consignee details. Item 2 identifies the delivery receipt with shipment details. This dialog box contains the equivalent information found on a delivery receipt. The user can scroll down to read more information. Specific details provided depend upon the nature of the shipment. Item 3 is a box to check or uncheck. A signature may occur with this statement: “Received in Good Condition except as Noted. Shrink Wrap Intact Unless Otherwise Indicated.” Item 4 indicates the signature area where a consignee signs for the delivery. Item 4a is where “Yes, Shrink Wrap Intact” may appear in the signature box if the associated check box is checked; this phrase may be encoded as part of the actual signature block sent to the computer network. Item 4b is the text representation of the name of the person signing for the delivery. Item 4c is the signature itself, in this case the signature of Jane Doe. Item 4d is the actual date of the signature. The signature is encoded with the signature and shown on the paperless delivery receipt delivered to the consignee. Item 5 is a box in which the user scrolls down to review more shipment details such as the shipper. Information provided to the user is determined by business needs, for example. FIG. 6 also illustrates that there are buttons that may be touched on the screen or tablet. A “Clear” button allows the consignee to clear the hand written signature and sign it again. An “Accept” button is used by the consignee to accept the shipment detailed on that screen. A “Skip” button allows the consignee to not accept a shipment. This allows the consignee to discuss details of the specific shipment and either request an OS&D exception or at least note details associated with the shipment.

FIG. 7 illustrates a user interface for Accessorial Services. As illustrated in the computer screen shown in FIG. 7, item 1 illustrates that the driver can select from a variety of services that the driver performed at a stop. Item 2 illustrates that some services may be specified at a STOP level, such as Waiting in Line, while other services may be specific to unique shipment such as Sort and Segregate Freight. Item 3 illustrates that other information, such as piece count or time taken for the task may be entered based on the business needs.

FIG. 8 illustrates a user interface for a tally count. Item 1 shows that the driver can enter tally notes as the number of items on a palette is totaled. No ink is presented. For example, a signature is written by a human using a stylus and the handheld displays a continuous stroke of pixels corresponding to the path of the stylus which looks like ink from a pen. Item 2 presents a history of the calculations. Item 3 illustrates that instructions on using the form are presented. Item 4 illustrates the name of the shipper and the specific PRO number being tallied. Item 5 is the expected piece count. Piece count is the handling units. Item 6 is the actual piece count. In the example shown in FIG. 7, the tally is not yet complete. Once the driver presses the “Enter” key, the additional two cartons will be added to the tally and the driver can then save the tally. Buttons are presented that have functionality. The “Reset” button clears all tally items for a given PRO number. The “Undo” button clears a pending entry. The “Cancel” button exits without saving changes. Valid keyboard keys include: number pad digits 0 to 9, “Enter” or “ENT” which enters the number and adds it to the total, “Escape” or “ESC” which will undo or remove the last number, and “Backspace” which deletes the last digit entered.

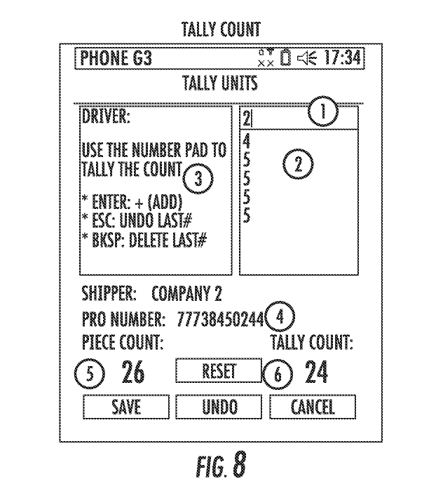

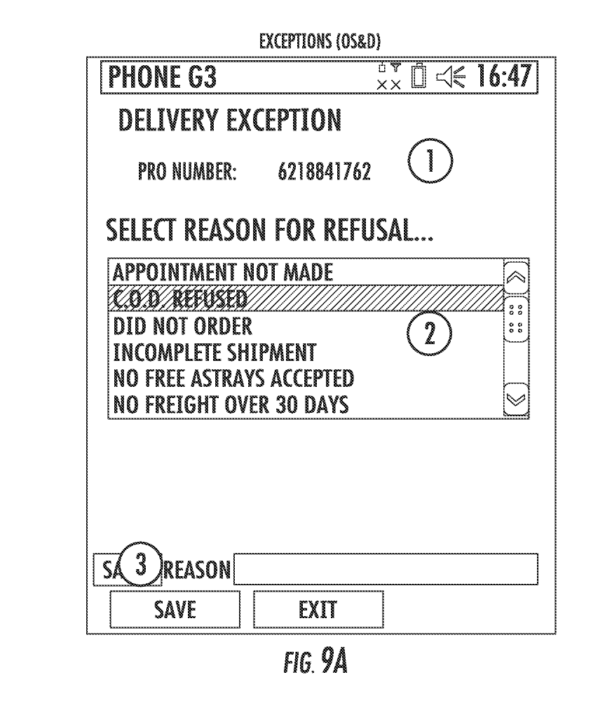

FIG. 9A illustrates a user interface showing a “Delivery Exception.” Delivery exceptions consist of a wide range of issues including, but not limited to, damage. For example, a carrier may fail to make an appointment ahead of time and thus not be able to deliver the shipment to the consignee. Item 1 illustrates that a driver can document exceptions associated with a specific shipment. Item 2 illustrates a list is available from which the driver may select a reason for delivery failure such as appointment not made, C.O.D. refused, did not order, incomplete shipment, among others. Notes can be entered on specific choices or other reasons can be entered as shown in item 3. Once the selection is complete, the driver can exit back to the regular “Stop Detail” screen.

FIG. 9B illustrates a user interface showing a signature screen for exceptions. Item 1 illustrates that a consignee is able to sign his name confirming a documented exception. The refusal documentation and other information are captured and available for the consignee on the signature screen. Item 2 illustrates that the actual signature may reflect the refusal ensuring the consignee is comfortable acknowledging the refusal. Note that a signature from the consignee is not required. The consignee can click the “Refuse” button to associate his signature with the refused shipment or the “Skip” button if the consignee prefers not to be on record refusing the shipment.

FIG. 9C is a user interface illustrating other types of damage. Item 1 illustrates that damages or other exceptions are tracked for a specific shipment. Item 2 illustrates that various exceptions are tracked based on business needs. Item 3 illustrates that the driver may enter notes about the damage Item 4 illustrates that reference numbers are tracked with the shipment based on business requirements. Item 5 illustrates that a photo subsystem augments exception information utilizing the camera infrastructure of the mobile device and the existing “Signature” communication and storage technology of the carrier.

FIG. 10A is a user interface illustrating other graphical and generic file and data types for delivery exception photographic documentation. The “Photos” button allows a driver to capture photos of damaged freight. FIG. 10B shows a photographic documentation subsystem. Item 1 shows that photos are captured on the device. Item 2 indicates that photos are communicated to the computer network using the same infrastructure used to track, store, and lookup signatures. This infrastructure can also be used for other types of documents and photographs.

Another feature of the present invention is a user interface is for electronically documenting accident scenes without additional camera equipment, film, scanning, or storage devices. The user can document details of an accident scene including the time the driver was at the scene, actual photographic images, GPS information, and other items including verbal recording, and hand written notes.

FIGS. 11A-11D illustrate an accident photo user interface in accordance with aspects of the present invention. As shown in FIGS. 11A-11D, the user interface allows the driver to capture images from the accident screen as well as the time associated with the accident. Once a driver starts the “accident” delay of item 1, the service center is notified that the driver has been in an accident. Each photo is also time stamped with the date and time the image was taken. Other macro data is also collected with the accident photos including GPS coordinates. This information is then uploaded to a server or computer where it is retained and used in the filing of accident reports for insurance and legal purposes.

As shown in FIG. 11A, accident status is reported as a type of delay. A driver selects, for example, “accident” as one of the many possible delay types and selects start. As shown in FIG. 11B, after the driver presses the “Start” button, the beginning time shown as item 2a and end time shown as item 2b are displayed. The handheld device then notifies a service center that an accident has occurred. The driver then presses the “Stop” button to indicate that he has completed accident related activities. The beginning and end times are recorded and sent back to a computer system database. The service center is notified of the change in status. As shown in FIG. 11A, the “Start” button enables the screen shown in FIG. 11B and begins tracking time associated with the accident. The “Start” button also notifies the service center that an accident for that driver has occurred. Information about the driver, route, GPS, location and other information is also encoded and sent back to the servers. Selection of the “Exit” button leaves the delay screen to return to the application main screen and notifies the service center that the accident related activities are complete. Data associated with the accident are uploaded to a server or computer. The “Stop” button stops the timer count and time from being tracked. The “Camera” button enables the camera subsystems. A driver may select the “Camera” button from the delay screen to take a photograph. Selecting the “Camera” button brings up the camera dialog and starts the camera screen shown in FIG. 11C.

As shown in FIG. 11C, the accident photo system provides a camera user interface and view finder to allow a driver to record accidents and other information about an accident. The driver uses the view finder interface to point the camera at the scene. Once the driver has framed the scene to be captured, the driver presses a physical keyboard key such as an “Enter” button or other designated key to take a photo shown at item 3c. The picture count shown below item 3b is incremented so the driver knows how many pictures have been taken. Optionally, the user interface may display the number amount of space left for pictures, or the number of pictures that can still be taken. After pressing the “Enter” key, the camera view finder superimposes a “Wait” icon, such as an hourglass shape, on the photograph indicating that a picture is being captured. A sound may also be played during the acquisition process reminding the driver that a picture is being captured. A “Listen” icon, for example, means that the sound plays until the photo is complete. Once the picture is completely captured, the sound stops, the “wait” icon disappears, and the picture count is incremented. The following are examples of other buttons. A “Lamp” button shown at item 3a enables the LED light for night time or dark situations and turns off/on the camera flash. An “Exit” button exits the camera graphical user interface (GUI) and subsystems including the camera screen. A “View” button allows the driver to view a current set of photographs.

FIG. 11D is a magnified excerpt of a photograph (shown at 4) showing the date and time stamp actually recorded as part of the image. Optionally, other machine readable macro data is also encoded in the image file (such as XML in a JPEG file), or such data is recorded in a database and associated with the image. This information includes, but is not limited to, GPS, more detailed time information, driver information, and other information needed for accident reporting.

There are other potential features of the computer system and method of the present invention. For example, the computer system has the functionality for a driver to collect an email address from the consignee at the point of delivery. Another feature is a photograph subsystem. Another feature is a “sign once for all shipments” capability. Another feature is a handheld computer with changes to the delivery receipt information made after the driver departs the employer location at the beginning of the day, for example. Another feature is to send back to employer location at the end of the day the hand written signatures that are electronically collected at point of delivery. Another feature is to provide paperless delivery receipts for home service deliveries.

It will therefore be readily understood by those persons skilled in the art that the present invention is susceptible of broad utility and application. Many embodiments and adaptations of the present invention other than those herein described, as well as many variations, modifications and equivalent arrangements, will be apparent from or reasonably suggested by the present invention and the foregoing description thereof, without departing from the substance or scope of the present invention. Accordingly, while the present invention has been described herein in detail in relation to a particular embodiment, it is to be understood that this disclosure is only illustrative and exemplary of the present invention and is made merely for purposes of providing a full and enabling disclosure of the invention. The foregoing disclosure is not intended or to be construed to limit the present invention or otherwise to exclude any such other embodiments, adaptations, variations, modifications and equivalent arrangements.

What is claimed is:

1. A networked computer system comprising:
a computer or a server having a computer software application for generating a paperless delivery receipt for a shipment by a carrier,
a mobile device for downloading the paperless delivery receipt, and
a computer user interface on the mobile device for capturing an electronic signature associated with the paperless delivery receipt.

2. The networked computer system according to claim 1, wherein the computer software application is operated by or on behalf of a carrier.

3. The networked computer system according to claim 1, wherein the assembled data comprises shipment information, shipper information, consignee information, route information, or a combination thereof.

4. The networked computer system according to claim 1, wherein the mobile device is a phone or other handheld device.

5. The networked computer system according to claim 1, wherein the computer software application user interface on the mobile device is used to communicate with the computer or the server.

6. The networked computer system according to claim 1, wherein the mobile device comprises a touch screen.

7. The networked computer system according to claim 6, wherein the touch screen is a resistive touch screen.

8. The networked computer system according to claim 6, wherein the touch screen is a capacitative touch screen.

9. The networked computer system according to claim 1, wherein the mobile device further comprises a camera for capturing a photographic image.

10. The networked computer system according to claim 1, further comprising a graphic computer data file having captured an electronic signature.

11. A method of providing a paperless delivery receipt with electronic signature, the method comprising:
assembling data for a paperless delivery receipt for a shipment by a carrier using a computer software application a computer or a server in a networked computer system,
downloading the paperless delivery receipt from the computer or the server to a mobile device,
capturing an electronic signature of a recipient of the shipment on the mobile device, merging the electronic signature and the paperless delivery receipt into a graphic computer data file, and
wirelessly transmitting the graphic computer data file to the computer or the server in the networked computer system.

12. The method according to claim 11, wherein the networked computer system is operated by or on behalf of a carrier.

13. The method according to claim 11, wherein the mobile device is a phone or other handheld device.

14. The method according to claim 11, wherein the mobile device has a full featured operating system.

15. The method according to claim 11, further comprising receiving information about the shipment by the computer or the server entered from the mobile device.

16. The method according to claim 15, further comprising using the received information in the paperless delivery receipt.

17. The method according to claim 11, wherein the mobile device comprises a touch screen.

18. The method according to claim 11, further comprising providing a signature screen by the computer software application.

19. The method according to claim 11, further comprising providing the paperless delivery receipt at point of delivery to consignee.

20. The method according to claim 19, further comprising e-mailing a copy of the paperless delivery receipt to consignee.

21. The method according to claim 11, further comprising receiving information about close of a trailer prior to assembly of data.

22. The method according to claim 11, further comprising downloading route data with the delivery receipt.
